(19) United States
(12) Patent Application Publication
(10) Pub. No.: US 2024/0061727 A1
(43) Pub. Date: Feb. 22, 2024

(54) SYSTEM FOR ENABLING TEMPORAL STRUCTURAL METADATA CHANGES USING VIRTUAL ADDRESSING OF DATA

(71) Applicant: Cinchy Inc., Toronto (CA)

(72) Inventors: Karanjot SINGH, Toronto (CA); Daniel DEMERS, Toronto (CA); Connor FOWLIE, Toronto (CA)

(21) Appl. No.: 18/386,401

(22) Filed: Nov. 2, 2023

Related U.S. Application Data
(63) Continuation of application No. PCT/CA2022/050795, filed on May 19, 2022.
(60) Provisional application No. 63/191,265, filed on May 20, 2021.

(51) Int. Cl. G06F 9/54

(52) U.S. Cl. CPC G06F 9/541

(57) ABSTRACT

The following provides a method of modifying or deleting existing parts of an API while preventing breaking changes is taught herein. The method comprises assigning unique identifiers (ID) to the data. The unique identifier is a data address comprised of data coordinates and a context. The data coordinates further comprises a network ID, and a dataset ID. With this information, it is possible to identify and recall any data located within a network of data. The context further comprises a time ID and a timeline ID. Any data can be provided with a unique identifier such that the data can be recalled at any moment in time. This allows a user or programmer to make modifications or deletions to an API, interface, or a database without inducing a breaking change. This method allows for transient virtual addressing of data.

### TECHNICAL FIELD

The following relates to breaking changes and methods of preventing breaking changes when accessing data that has been modified. In a specific embodiment, the following relates to application programming interfaces (APIs), and data stored in a persistent manner accessed by such application programming interfaces.

### BACKGROUND

An API (Application Programming Interface) is a computing interface that defines interactions between multiple software applications or mixed hardware-software intermediaries. It defines the kinds of calls or requests that can be made, how to make them, the data formats that should be used, the conventions to follow, etc. An API can include a set of rules that allow a variety of programs to talk to each other. A developer can create the API on a server and allow the client to interact with and access it. An API integration is the connection between two or more applications, via their APIs, that lets those systems exchange data. This information, or representation, can be delivered in one of several formats via HTTP; for instance: JSON (JavaScript Object Notation), HTML, XLT, PHP, or plain text.

In some API call formats, for example a REST-API format, may require that custom headers be sent with the HTTP request. Headers may contain important identifier information as to the request's metadata, authorization, uniform resource identifier (URI), caching, cookies, and more. Types of headers include request headers and response headers, each with their own HTTP connection information and status codes.

One challenge faced by software programmers is that of managing change. Software companies may want to continually evolve their offerings by adding new features and improving old features to maintain their competitive edge. However, it is known that continuity is paramount to programmers. Therefore, changes should have minimal impact on existing integrations.

Breaking change is a significant concern in the world of API connections. Breaking changes can cause applications to fail. A breaking change to an API is any change that can break an application. Usually, breaking changes involve modifying or deleting existing parts of an API and/or the underlying database(s).

Modification of existing parts of an API carries a risk of breaking applications. Deleting existing parts of an API can cause the application to break. For instance, if a client was previously consuming a now deleted or modified resource, field, or structure, parts of their application will cease to function. The extent to which this really “breaks” the application can vary greatly, from having a minor cosmetic effect to making the application entirely unusable. This can lead to wasted time, wasted money, and wasted resources for the software company as they will now have to spend the time, money and resources fixing the breaking change problems.

Common examples of breaking changes include deleting a resource or method; deleting a response field; modifying a resource or method URI; modifying a field name; modifying required query parameters; and modifying authorization.

For instance, imagine two users accessing two different APIs which query a single database. Within the database, there is a column which refers to “Employee Names”. User A then modifies the column name and refers to it as “Worker Names”. At that moment, the 2 nd API, used by user B breaks as there is no link to the column “Worker Names”, only to the non-existent column “Employee Names”.

In another instance, if there is an email address known as “chrisb@email.com” and this email address is later changed to “chris123@email.com”, a person sending a message to chrisb@email.com after the email has been changed, would get an error notification.

In yet another instance, if there is an URL web address known as “www.website.com/chrisb” and this URL is later changed to “www.website.com/chris123”, a person trying to resolve “www.website.com/chrisb” after the URL has been changed, would get an error notification.

As such, the breakage of the link to the API can have massive problems when scaled to a larger infrastructure. It can result in wasted time, wasted money, and wasted resources.

Improved data systems are needed.

### SUMMARY

The following provides a method of modifying or deleting existing parts of an API while preventing breaking changes is taught herein. The method comprises assigning unique identifiers (ID) to the data. The unique identifier may comprise data coordinates, a data address, and a context. The data coordinates may further comprise a network ID, a dataset ID, and a column ID. The data address may further comprise a row ID. With this information, it is possible to identify and recall any data located within a network of data. The context may further comprise a time ID and a timeline ID. Any data can be provided with a unique identifier such that the data can be recalled at any moment in time. This allows a user or programmer to make modifications or deletions to an API or a database without inducing a breaking change. This method allows for transient virtual addressing of data.

### BRIEF DESCRIPTION OF THE DRAWINGS

Embodiments will now be described with reference to the appended drawings wherein:

FIG. 1 is a schematic diagram illustrating the app-centric data model;

FIG. 2 is a schematic diagram illustrating a data-centric data model;

FIG. 3 is a schematic diagram of a domain;

FIG. 4 is a schematic diagram of a network of domains;

FIG. 5 is a schematic diagram illustrating a copy based integration model;

FIG. 6 is a schematic diagram illustrating a collaboration-based integration model;

FIG. 7 is a schematic diagram illustrating the data network;

FIG. 8A is a schematic diagram illustrating one embodiment of the data protocol;

FIG. 8B is a schematic diagram illustrating another embodiment of the data protocol;

FIG. 9A-9D show a schematic diagram illustrating the use of the data protocol within an example API; and

FIG. 10 shows a schematic diagram illustrating the use of a timeline.

### DETAILED DESCRIPTION

An API integration 16 is the connection between two or more applications 10, via their APIs 14, that lets those systems exchange data. APIs 14 are also useful for applications 10 that communicate with databases 11. The term API herein refers to an “Application Programming Interface”. The underlying data-protocol can use used for the management of any type of data, for example: changes in Web-URLs, REST-API, URLs, username, email addresses, or changes in any other kind of data. For example, the data can be in any alternate format of data storage (i.e., in some embodiments the dataset could be formatted as, for example, a row store, column store, JSON, parquet, HTML, XML, in memory cache, etc.). It is not pertinent what contents of data are stored, as long as the data is structured and accessible.

Software companies continually evolve their offerings by adding new features and improving old features to maintain their competitive edge. However, continuity is paramount to programmers as it prolongs the life of the software. Therefore, new changes to the API 14 should have minimal impact on existing integrations 16. The breakage of the link to the API 14 can have massive problems when scaled to a larger infrastructure. It can result in wasted time, wasted money, and wasted resources.

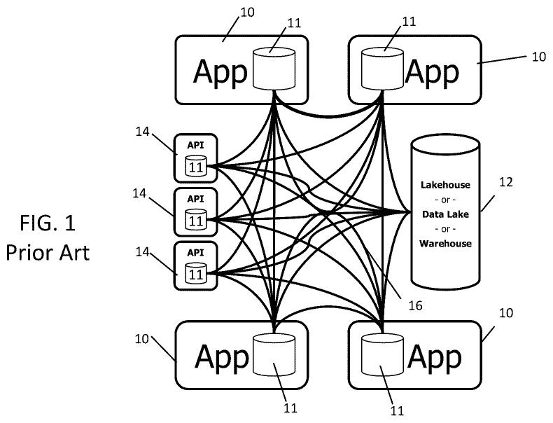

Turning now to the figures, FIG. 1 is a schematic diagram illustrating a traditional app-centric data model. FIG. 1 shows the API web-based application model which is what has been traditionally used. In his model, there are connections between a number of applications 10, via their APIs 14, that lets those systems exchange data. Each application 10 maintains its own database 11 and provides a copy of that database when requested by the API 14. This results in many applications 10, many data silos 11 and ultimately many integrations 16 needed. In this model, if a programmer modifies or deletes existing parts of an API 14, it may result in a breaking change. This could prove fatal to a subsequent API and cause it to crash or fail. Breaking changes in an app-centric data model can prove catastrophic to the applications that use them. This can lead to wasted time, wasted money, and wasted resources for the software company as they will now have to spend the time, money and resources fixing the breaking change problems.

A method of modifying or deleting existing parts of an API while preserving the API so as to prevent breaking changes is taught herein. The term “plasticity” used herein refers to the method of allowing modifications or deletions to be made to an API 14 or a database 11 without inducing a breaking change. The method provides immunity from schema evolution induced breakage of API 14.

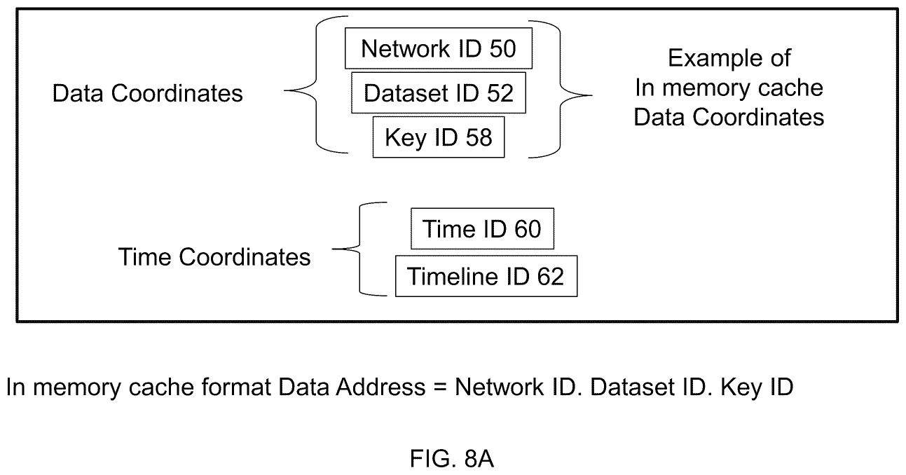

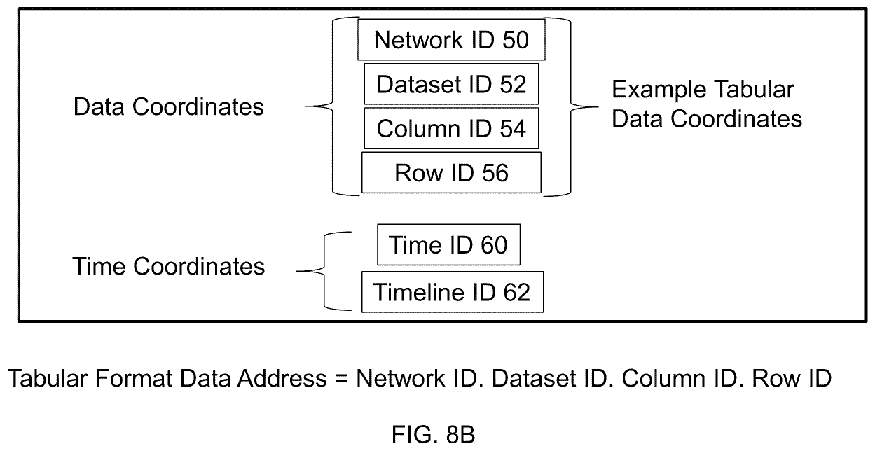

The following provides a method of modifying or deleting existing parts of an API while preventing breaking changes is taught herein. The method comprises assigning unique identifiers (ID) to the data. The unique identifier is a data address comprised of data coordinates and a context. With reference to FIG. 8B, the data coordinates preferably further comprises a network ID, a dataset ID, a column ID 54 and a row ID 56. With this information, it is possible to identify and recall any data located within a network of data. In some embodiments, the data address can be transient. In alternative embodiments, the data address can be perpetual. In yet another embodiment, some components of the data address are transient (such as the row ID 56) and some components of the data are perpetual (network ID 50, Dataset ID 52 and Column ID 54). As such, the row ID 56 may change. The context further comprises a time ID 60 and a timeline ID 62. Any data can be provided with a unique identifier such that the data can be recalled at any moment in time. This allows a user or programmer to make modifications or deletions to an API, data, a database, or data fabric without inducing a breaking change. This method allows for transient virtual addressing of data.

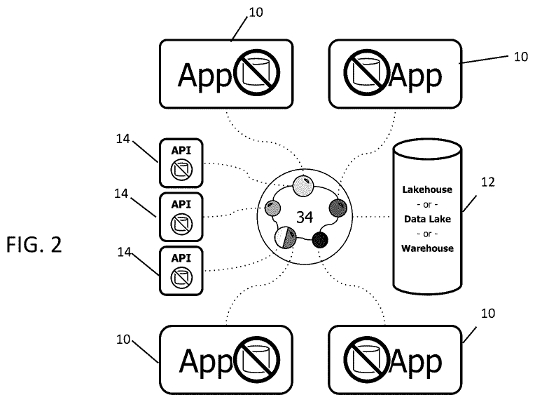

FIG. 2 is a schematic diagram illustrating a data-centric data model. In this model, the applications 10 themselves do not maintain their own databases. Instead, the data are maintained on a common server 34 which is accessible by all applications 10. This is referred to in U.S. application Ser. No. 17/307,571 which is incorporated herein by reference.

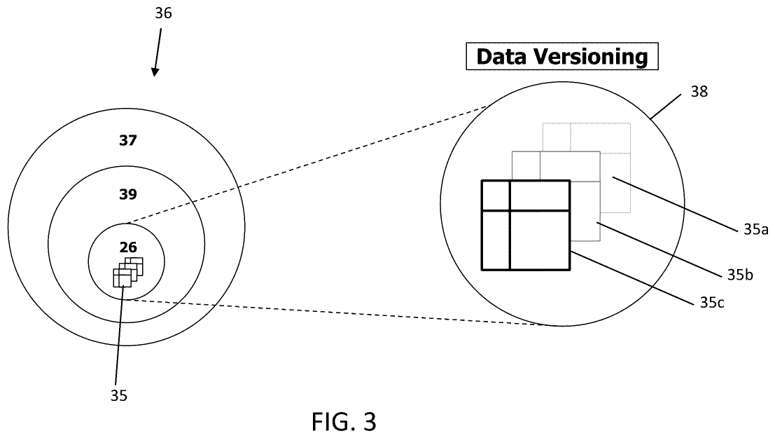

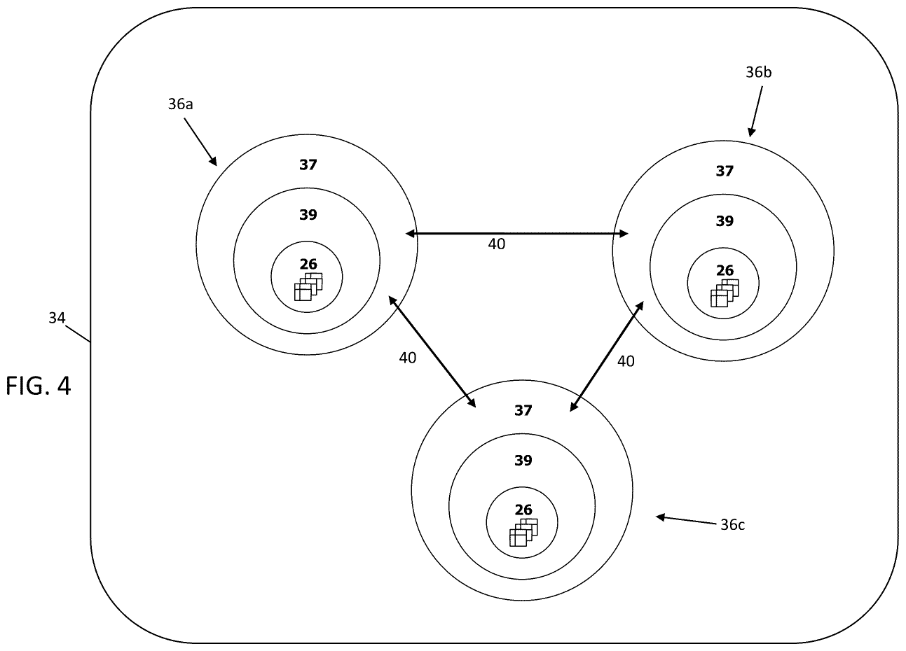

FIG. 2 illustrates a platform that is configured to manage data as a network of datanodes. FIG. 3 illustrates an example of a dataset node 36, also referred to as domain 36. FIG. 4 illustrates an example of a network 34 of domains 36. Each dataset 26 comprises data 35. The dataset is version controlled 38 and contains versions of data such as a first version 35a, a second version 35b, and a third version 35c. It can be appreciated that any number of versions are possible. An access-controls layer 39 is built atop the dataset 26. A metadata layer 37 is built atop the access-controls layer 39. As seen with the single domain 36 shown in FIG. 3, at a node's core are records of data 35. The records of data 35 cannot be accessed without first going through the metadata layer 37 and the access-controls layer 39. The domain 36 comprises metadata layer that makes the domain 36 self-describing and self-connecting. Therefore, each dataset 26 comprises its own metadata layer 37 that contains information about the dataset such as properties and information regarding its relationships with other nodes (i.e., links), along with the data that relates any record in the current node with one or more records in other nodes.

The domain 36 can be self-controlling by having a built-in control layer 39 to ensure the integrity of data, and to offer governance controls such as data versioning 38 and change approval. The domain 36 can be self-securing meaning that it has a built-in security layer to manage entitlements. The node is also accessible both through the platform's metadata driven user interface or API.

This eliminates the need for making copies and prevents data silos from occurring. Furthermore, the data-centric model does not require need for system-level integration.

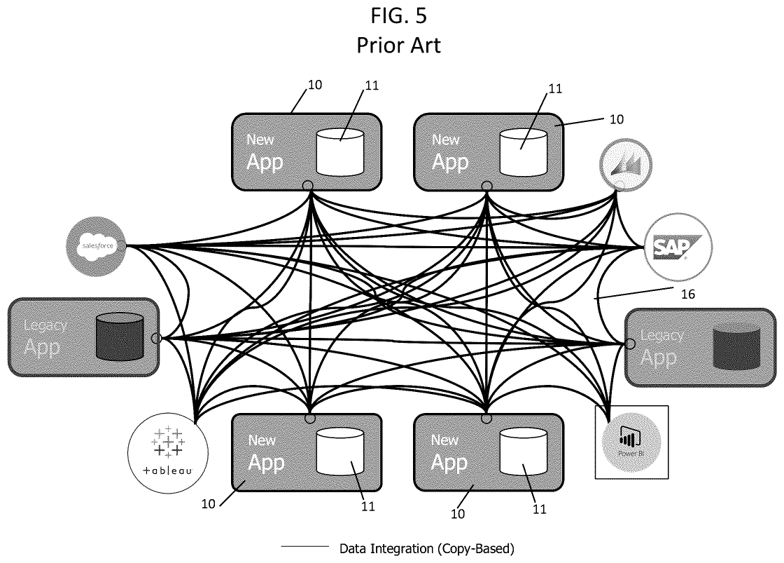

FIG. 5 is a schematic diagram illustrating a copy based integration model. Each of the traditionally developed applications 10 would require their own databases with linked or related data in the database 24 being created, imported, updated, maintained, etc. Each of the databases 24 stores a copy of the data 26 to be accessed by the application 10. Traditional applications have datasets embedded within. Traditionally, data is stored as copies of data in data silos 24 behind individual applications 10. This can cause a data-silo like environment, which can be disadvantageous in terms of storage space processing speeds and operating costs.

An integration 16 is a connection between two or more applications 10, via their APIs 14, that lets those systems exchange data. The copy-based integration model requires an application 10 to maintain its own database 11 and provides a copy of that database 11 when requested by the API 14 of a subsequent application 10.

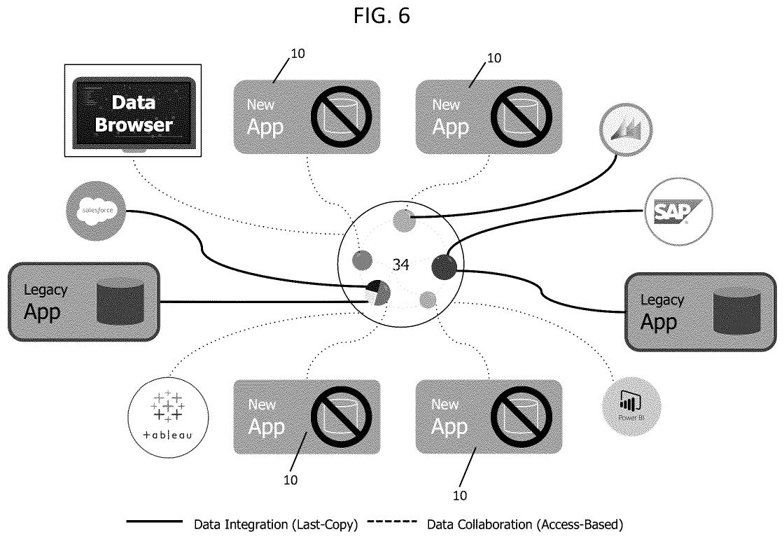

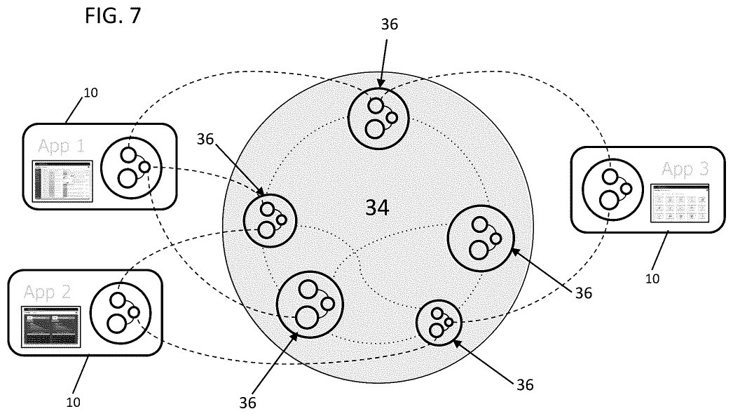

FIG. 6 is a schematic diagram illustrating a collaboration-based integration model. FIG. 7 is a schematic diagram illustrating the collaborative data model. The data network shown in FIGS. 6 and 7 are composed of the individual data domains 36 comprising datasets from a plurality of applications 10. In these models, the applications 10 themselves do not maintain their own databases. Instead, the data is maintained on a common server 34 which is accessible by all applications 10. This eliminates the need for making copies and prevents data silos from occurring. Furthermore, the data-centric model does not require need for system-level integration. The legacy applications and CRM software such as Salesforce, SAP, etc., can provide a final copy of their data to the data network. New applications can directly use the data network to access and store the data. As such, no integration is needed in order to access one application's data from another application.

FIGS. 8A and 8B show various embodiments of the illustrating the data protocol. FIG. 8A shows an Example of in-memory-cache Data Coordinates. The identifiers can use any form of uniquely identifiable system such as GUID (globally unique identifier) or a UUID (universally unique identifier). As such, assigning unique identifiers to cell-level of data can be useful for cell level customization, cell level security and cell level history. Cell level customization allows a user to customize their view of the database, to the cell level.

As long as the dataset is in a structured format, the mapping between the transient data and the perpetual address can be maintained. As such, this is possible even if the dataset is not in a row/column store format. For example, the dataset can be any alternate format of data storage (i.e., in some embodiments the dataset could be formatted as, for example, a row store, column store, JSON, parquet, HTML, XML, in memory cache, etc.). It is not pertinent what contents of data are stored, as long as the data is structured and accessible. In this instance, the data address can be modified to uniquely identify key-value pairs within the dataset. FIG. 8A shows an embodiment where the data coordinates are comprised of the network ID 50, the dataset ID 52, and the key ID 58. In FIG. 8B, the data coordinates comprise a network ID 50, the dataset ID 52, a column ID 54, and Row ID 56. The row ID 56 and column ID 54, as well as the key ID 58 are all examples of types of data-specific unique identifiers, or record IDs. The column and row ID, and key ID 58 are all examples of mechanisms of uniquely identifying data within the dataset.

In one embodiment, a system for manipulating data stored on a network comprising: a uniquely identifiable virtual address comprising: data coordinates having a network ID 50, dataset ID 52; a column ID 54 and a row ID 56; and a time context having a time ID 60 and timeline ID 62 is provided. The network ID 50 being used to identify to a network of datasets; the dataset ID 52 being used to identify to a particular dataset; the column ID being used to identify to a column within the dataset; the row ID being used to identify to a row within the dataset; the time ID being used to provide the time context to the manipulation of data; the timeline ID being used to identify the timeline context for the data address. The system may also comprise an autonomous historical log for keeping a record of all manipulations made to the data. This virtual addressing of data gives it the ability to change the data value through time, while the address remains constant. The system treats the metadata, i.e., any kind of structural data (for example: column name, column type, linkage to other tables) as data. The system also maintains the mapping between the name of the column and the column ID; therefore, it is managing the metadata in the same way it manages data. In one embodiment, the system generates and maintains a table of all the tables or datasets (i.e., a “tables” table). Schema evolution can therefore be achieved by changing the data associated with the ID in the “tables” table.

As such, using this model allows for plasticity. Plasticity allows any user to make a change, modification or deletion to the data set or the API while maintaining a non-breaking change. For instance, a user may change the name of a column. Since the column is associated with its own unique identifier, the column identifier is not dependent on the alias given to it. This enables the ability to change/manipulate the data through time without inducing breaking changes if the system is accessing the schema via its perpetual IDs.

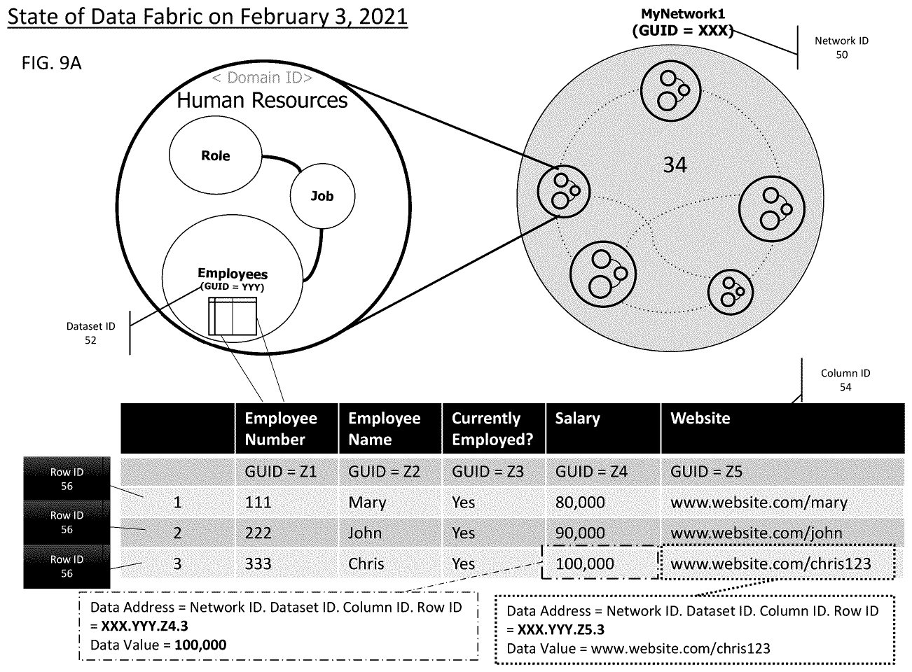

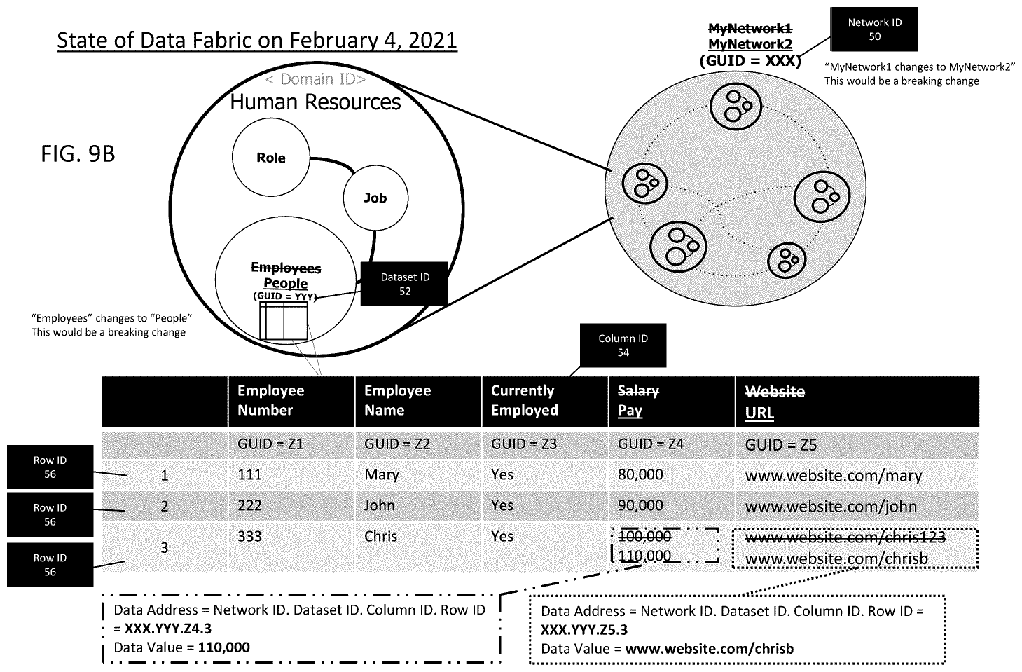

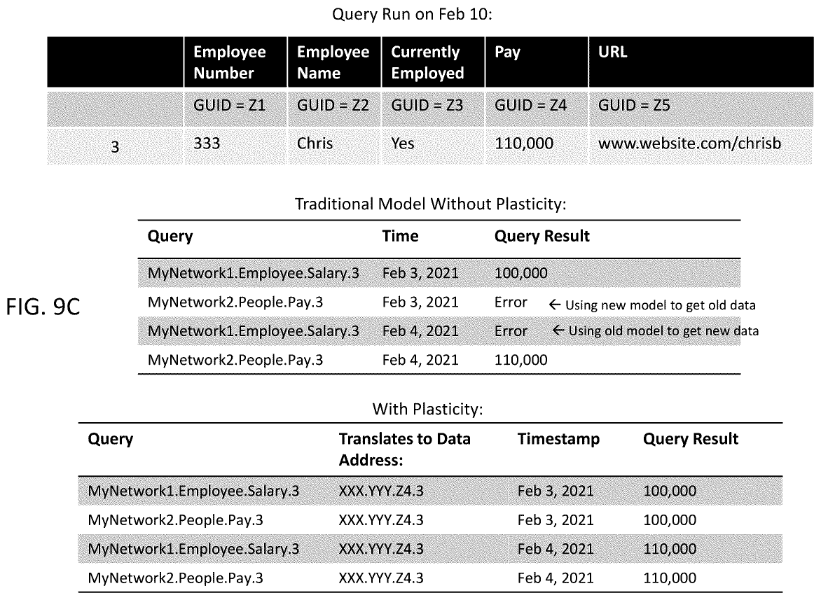

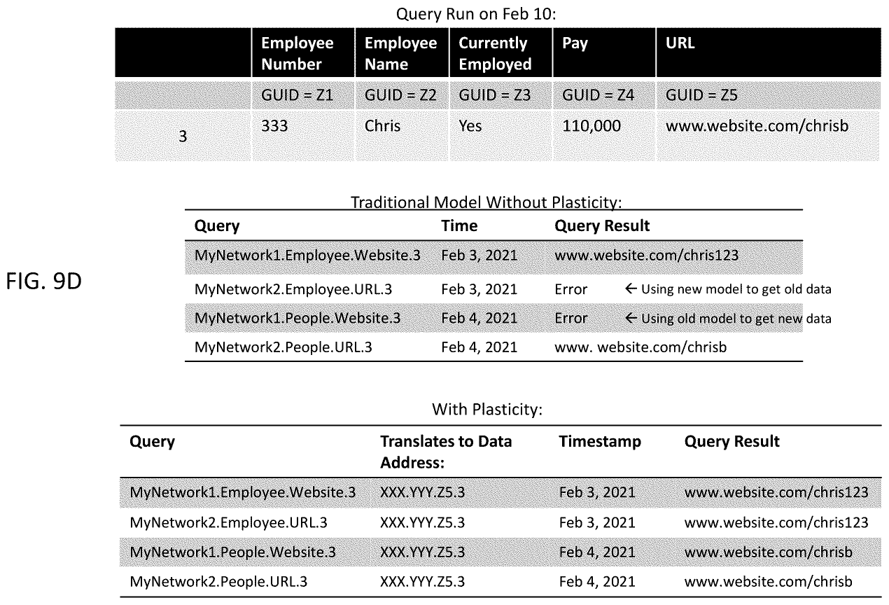

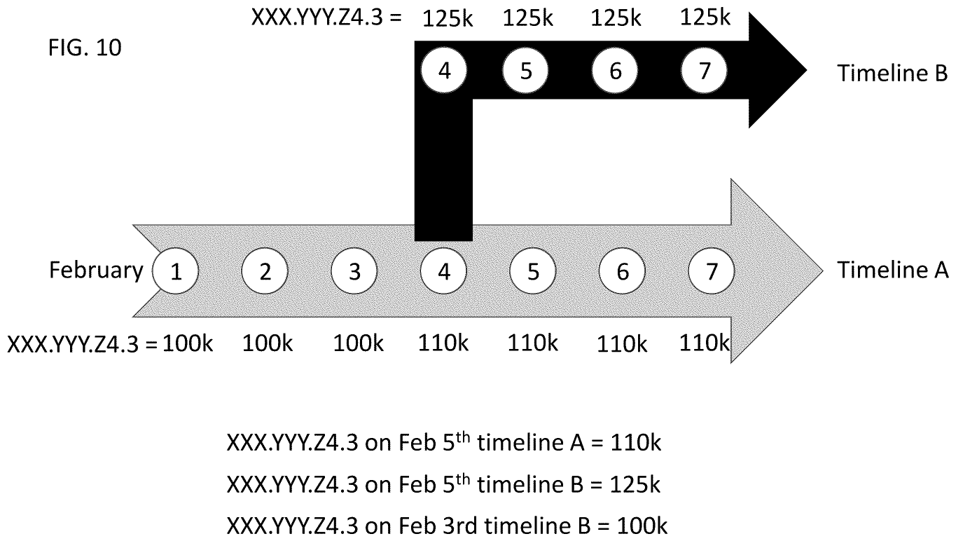

FIG. 9A-9D show a series of schematic diagrams which help to illustrate the use of the data protocol within an example API to enable plasticity. In this embodiment, the data coordinates shown are of the row store or tabular format, but it can be appreciated that any data format can be used.

FIG. 9A illustrates an example of a data network known by its friendly name as “MyNetwork1”. FIG. 9A illustrates the state of the data fabric as of Feb. 3, 2021. The data network also has a Network ID (i.e. a globally unique identifier (GUID)) associated with it. In this example, the GUID for the data network is “XXX”. The data network is comprised of multiple domains. Within each domain, there are multiple datasets (or tables of data). In one example, there is a dataset within the domain; the friendly name of the dataset is known as “Employees”. The dataset also has a Dataset ID 52 associated with it, namely “YYY”. Within the dataset known as “Employees”, there exists a table having 4 columns and 3 rows. Each of the columns is given a unique Column ID. The column ID for the column known as “Employee Number” is Z1; the column ID for the column known as “Employee Name” is Z2; the column ID for the column known as “Currently Employed” is Z3; the column ID for the column known as “Salary” is Z4; and the column ID for the column known as “Website” is Z5. Each of the rows is given a unique Row ID. In this instance, the row ID for row 1 is 1; row 2 is 2; and row 3 is 3. The row ID may or may not be unique to the network. For instance, another table within the same domain may have the same set of Row IDs (1, 2, 3).

Within the network known as “MyNetwork1”, there is a domain known as “Human Resources”, within the domain, there is a dataset known as “Employees”, within the dataset, there is a column known as “Salary”, within the column, there is a 3 rd row. At this intersection, there is a cell that obtains the data value 100,000. However, as each cell of data located within the network is virtually addressed, it is possible to query each cell using this method. As such, this cell can be queried using the address given by: Network ID. Dataset ID. Column ID. Row ID=XXX.YYY.Z4.3.

The data address may optionally include a Domain ID to further distinguish the domains. However, in some instances, the Domain ID does not need to be specified in the data address if each dataset and dataset ID is unique to a given network. Furthermore, the data address may comprise more or less components of the address. As such, in some examples, it may be unique enough to simply query the data address given by the column and row IDs (i.e., address=Column ID. Row ID=Z4.3). For example, this would be possible if the system only comprises one dataset. In other instances, it may be necessary to add additional components to the address. For example, if multiple instances of the platform were running on one network, it may be necessary to differentiate between the instances using a subnetwork address.

FIG. 9B illustrates the state of the data fabric as of Feb. 4, 2021. In this example, the model has been changed. For instance, the “friendly name” of the Network is now “MyNetwork2”. The friendly name of the dataset that was known as “Employees” on Feb. 3, 2021 is now changed to “People”. The friendly name of the column that was known as “Salary” on Feb. 3, 2021 is now changed to “Pay”. The cell that previously had a value of 100,000 is now changed to 110,000. The friendly name of the column that was known as “Website” on Feb. 3, 2021 is now changed to “URL”. The cell that previously had a value of “www.website.com/chris123” is now changed to “www.website.com/chrisb”. As such, these would all constitute breaking changes. Traditionally, this could prove fatal to a subsequent API and cause it to crash or fail.

FIG. 9C illustrates the sample queries that can be run using the virtual addressing method. In this example, the query is run on Feb. 10, 2021. However, the query can be run at any time. Following the same example shown in FIGS. 9A-9B, one may assume that the model was changed on Feb. 4, 2021. Without the virtual addressing method, if the query MyNetwork1.Employee.Salary.3 was run for Feb. 3, 2021, the query result would be 100,000. Similarly, if the query MyNetwork2.People.Pay.3 was run for Feb. 4, 2021, the query result would be 110,000. This is because the query run does not constitute any breaking changes. However, if the query MyNetwork2.People.Pay.3 was run for Feb. 3, 2021, the query would result in an error. This is because the traditional system would be trying to use a new model to obtain old data, which is not possible traditionally. Similarly, if the query MyNetwork1.Employee.Salary.3 was run for Feb. 4, 2021, the query would also result in an error. This is because the traditional system would be trying to use an old model to obtain new data, which would also not be possible using traditional methods.

However, using the method of virtual addressing to enable plasticity, the following would occur. If the query MyNetwork1.Employee.Salary.3 was run for Feb. 3, 2021, the query result would be 100,000. Similarly, if the query MyNetwork2.People.Pay.3 was run for Feb. 4, 2021, the query result would be 110,000. If the query MyNetwork2.People.Pay.3 was run for Feb. 3, 2021, the query result would be 100,000. If the query MyNetwork1.Employee.Salary.3 was run for Feb. 4, 2021, the query result would be 110,000. This is because the query is first translated to its virtual data address. For all the queries, the virtual data address remains XXX.YYY.Z4.3. Furthermore, this data address remains perpetual, i.e., it can be used for any amount of time in the future.

FIG. 9D illustrates the sample queries that can be run using the virtual addressing method. In this example, the query is run on Feb. 10, 2021. However, the query can be run at any time. Following the same example shown in FIGS. 9A-9B, one may assume that the model was changed on Feb. 4, 2021. Without the virtual addressing method, if the query MyNetwork1.Employee.Website.3 was run for Feb. 3, 2021, the query result would be www.website.com/chris123. Similarly, if the query MyNetwork2.People.URL.3 was run for Feb. 4, 2021, the query result would be www.website.com/chrisb. This is because the query run does not constitute any breaking changes. However, if the query MyNetwork2.Employee.URL.3 was run for Feb. 3, 2021, the query would result in an error. This is because the traditional system would be trying to use a new model to obtain old data, which is not possible traditionally. Similarly, if the query MyNetwork1.People.Website.3 was run for Feb. 4, 2021, the query would also result in an error. This is because the traditional system would be trying to use an old model to obtain new data, which would also not be possible using traditional methods.

However, using the method of virtual addressing to enable plasticity, the following would occur. If the query MyNetwork1.People.Website.3 was run for Feb. 3, 2021, the query result would be www.website.com/chris123. Similarly, if the query MyNetwork1.People.URL.3 was run for Feb. 4, 2021, the query result would be www.website.com/chrisb. If the query MyNetwork2.Employee.URL.3 was run for Feb. 3, 2021, the query result would be www.website.com/chris123. If the query MyNetwork1.People.Website.3 was run for Feb. 4, 2021, the query result would be www.website.com/chrisb. This is because the query is first translated to its virtual data address. For all the queries, the virtual data address remains XXX.YYY.Z5.3. Furthermore, this data address remains perpetual, i.e., it can be used for any amount of time in the future.

For instance, the data protocol can be useful for correcting breaking changes from occurring in URL link changes, email address changes, username changes etc. For example, if chrisb@email.com is changed to chris123@email.com, a person sending a message to chrisb@email.com after the email has been changed, would traditionally get an error notification. With plasticity, the email address chrisb@email.com is first translated to a perpetual address. Therefore, when the email address is changed to chris123@email.com, the perpetual address remains identical. Then, if a person is sending a message to chrisb@email.com after the email has been changed, the server resolves it to its perpetual address, so it would be sent to the email address associated with the perpetual address. Therefore, anyone at any moment in time is able to resolve old and new email addresses in the same way. The data protocol can therefore be used for correcting breaking changes from occurring in any sort of data format including but not limited to: changes in Web-URLs, REST-API, URLs, username, email addresses, databased, or changes in any other kind of data.

In some embodiments, the data address can also be transient. In another embodiment, some components of the data address can be transient (such as the row ID) and some components of the data can be perpetual (network ID 50, Dataset ID and Column ID). As such, the row ID may change.

The context further comprises a time ID and a timeline ID. Any data can be provided with a unique identifier such that the data can be recalled at any moment in time. This allows a user or programmer to make modifications or deletions to an API or a database without inducing a breaking change. This method allows for transient virtual addressing of data.

The view of the database is customizable based on the person viewing it, only the person authorized to view the data.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures, and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the platform, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A system for preventing breaking changes due to schema evolution comprising:
a network;
a dataset within the network;
data within the dataset structured by a data format; and
data coordinates comprising at least one component for uniquely identifying data within the dataset;
wherein the data comprises structural data that is managed in the same manner as data; and wherein the at least one components are determined by the data format.

2. The system of claim 1, wherein the data format comprises at least one of: row store, column store, JSON, parquet, XML, HTML and in-memory cache.

3. The system of claim 2, wherein the data coordinates for a row or column store data format comprises a uniquely identifiable virtual address comprising:
the data coordinates having a network ID; dataset ID; and a record ID;
the network ID being used to identify the network the data is located in;
the dataset ID being used to identify the dataset the data is located in; and
the record ID being used to identify the data located in the data format.

4. The system of claim 3, wherein the record ID comprises a column ID being used to identify to a column within the dataset; and a row ID being used to identify to a row within the dataset.

5. The system of claim 2, wherein the data coordinates for JSON and parquet data formats comprise a key ID being used to identify data within the dataset.

6. The system of claim 1, wherein the system further comprises a time context having a timestamp and timeline ID;
the timestamp being used to provide the time context to the manipulation of data; and
the timeline ID being used to identify the timeline context for the data coordinates.

7. The system of claim 1, wherein the system further comprises an autonomous historical log for keeping a record of all manipulations made to the data.

8. A method for preventing breaking changes due to schema evolution comprising:
providing a network;
providing a dataset within the network;
providing data within the dataset organized in a data format;
uniquely identifying data within the dataset using data coordinates comprising at least one component; and
managing structural data as data.

9. The method of claim 8, the data format comprises at least one of: row store, column store, JSON, parquet, and in-memory cache.

10. The system of claim 9, wherein the data coordinates for a row or column store data format comprises a uniquely identifiable virtual address comprising:
the data coordinates having a network ID; dataset ID; and a record ID;
the network ID being used to identify the network the data is located in;
the dataset ID being used to identify the dataset the data is located in; and
the record ID being used to identify the data located in the data format.

11. The method of claim 10, wherein the record ID comprises a column ID being used to identify to a column within the dataset; and a row ID being used to identify to a row within the dataset.

12. The method of claim 9, wherein the data coordinates for JSON and parquet data formats comprise a key ID being used to identify data within the dataset.

13. The method of claim 8, wherein the method further comprises:
providing a time context having a timestamp and timeline ID;
the timestamp being used to provide the time context to the manipulation of data; and
the timeline ID being used to identify the timeline context for the data coordinates.

14. The method of claim 8, wherein the method further comprises providing an autonomous historical log for keeping a record of all manipulations made to the data.
